(19) United States
(12) Patent Application Publication
(10) Pub. No.: US 2020/0322684 A1
(43) Pub. Date: Oct. 8, 2020

(54) VIDEO RECOMMENDATION METHOD AND APPARATUS

(71) Applicant: BEIJING BAIDU NETCOM SCIENCE AND TECHNOLOGY CO., LTD., Beijing (CN)

(72) Inventors: Liqiang DONG, Beijing (CN); Xiaodong CAO, Beijing (CN); Xinwei YU, Beijing (CN); Guoqing CHEN, Beijing (CN); Chunxin JIA, Beijing (CN); Su WANG, Beijing (CN); Jinsheng CHEN, Beijing (CN); Xi ZENG, Beijing (CN); Xin ZHANG, Beijing (CN); Jiaqi JIANG, Beijing (CN); Zhenhua LIU, Beijing (CN); Yueyang SONG, Beijing (CN); Shilei WEN, Beijing (CN); Fu LI, Beijing (CN); Hao SUN, Beijing (CN); Xiao LIU, Beijing (CN); Lixing GONG, Beijing (CN); Tianbao YU, Beijing (CN); Feng LI, Beijing (CN); Fei LI, Beijing (CN); Junling ZHAO, Beijing (CN); Haiping WANG, Beijing (CN); Yan XIA, Beijing (CN); Chao LI, Beijing (CN); Xiu WEI, Beijing (CN); Qi GAO, Beijing (CN)

(21) Appl. No.: 16/622,876

(22) PCT Filed: Jul. 18, 2018
(86) PCT No.: PCT/CN2018/096177

§ 371 Date: Dec. 13, 2019

(30) Foreign Application Priority Data
Dec. 7, 2017 (CN) 201711287361.9

(51) Int. Cl. H04N 21/466; H04N 21/488; H04N 21/44; H04N 21/431; G06F 16/735; G06F 16/783

(52) U.S. Cl. CPC H04N 21/4668; H04N 21/4882; G06F 16/783; H04N 21/4312; G06F 16/735; H04N 21/44008

(57) ABSTRACT

The present disclosure provides a video recommendation method and a video recommendation apparatus, a computer device and a storage medium. The video recommendation method includes: acquiring a target short video; identifying, from candidate long videos, a target long video that the target short video is from based on a video fingerprint feature of the target short video and video fingerprint features of the candidate long videos; and recommending the target long video.

### CROSS-REFERENCE TO RELATED APPLICATIONS

This application is a US national phase application of International Application No. PCT/CN2018/096177 filed on Jul. 18, 2018, which is based on and claims priority to Chinese Patent Application No. 201711287361.9, filed on Dec. 7, 2017, the entire contents of which are incorporated herein by reference.

### TECHNICAL FIELD

The present disclosure relates to the field of video processing technologies, and more particularly, to a video recommendation method and a video recommendation apparatus, a computer device and a storage medium.

### BACKGROUND

Compared with long videos with long duration, such as movies, TV series, and variety shows, short videos are easy to watch at any time due to its short duration and refining feature. Therefore, under this kind of user demand, short video technology has developed rapidly.

### SUMMARY

Embodiments of a first aspect of the present disclosure provide a video recommendation method.

The method includes: acquiring a target short video viewed by a user; obtaining, from one or more candidate long videos, a target long video that the target short video is from based on a video fingerprint feature of the target short video and fingerprint feature of the one or more candidate long videos; and recommending the target long video to the user.

Embodiments of a third aspect of the present disclosure provide a computer device. The computer device includes a memory, a processor, and a computer program stored on the memory and operable by the processor. When the program is executed by the processor, the video recommendation method according to the above embodiments may be implemented.

In order to achieve the above objectives, embodiments of a fourth aspect of the present disclosure provide a non-transitory computer readable storage medium having a computer program stored thereon. When the program is executed by the processor, the video recommendation method according to the above embodiments may be implemented.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of embodiments of the present disclosure will become apparent and more readily appreciated from the following descriptions made with reference to the drawings, in which:

FIG. 1 is a flowchart illustrating a video recommendation method according to embodiments of the present disclosure.

FIG. 2A is a schematic diagram illustrating a playing page related to a video.

FIG. 2B is a schematic diagram illustrating a playing page related to a video.

FIG. 2C is a schematic diagram illustrating a playing page related to a video.

FIG. 2D is a schematic diagram illustrating a playing page related to a video.

FIG. 3 is a flowchart illustrating a video recommendation method according to embodiments of the present disclosure.

FIG. 4 is a schematic diagram illustrating multiple regions obtained by dividing a first key frame.

FIG. 5 is a schematic diagram illustrating a coordinate system XY.

FIG. 6 is a block diagram illustrating a video recommendation apparatus according to embodiments of the present disclosure.

FIG. 7 is a block diagram illustrating a video recommendation apparatus according to embodiments of the present disclosure.

FIG. 8 is a block diagram illustrating an exemplary computer device suitable for implementing embodiments of the present disclosure.

### DETAILED DESCRIPTION

Embodiments of the present disclosure will be described in detail and examples of embodiments are illustrated in the drawings. The same or similar elements and the elements having the same or similar functions are denoted by like reference numerals throughout the descriptions. Embodiments described herein with reference to drawings are explanatory, serve to explain the present disclosure, and are not construed to limit embodiments of the present disclosure.

In some application scenarios, the short video may be obtained by cutting a long video. After watching the short video, the user desires to acquire the long video that the short video is from. However, in the related art, the user needs to manually search for a relevant long video based on a title of the short video. In a case where the title of the short video is not related to content of the long video, the user is unable to find the long video.

Therefore, embodiments of the present disclosure provide a video recommendation method and a video recommendation apparatus, a computer device and a storage medium, which will be described below with reference to the accompanying drawings.

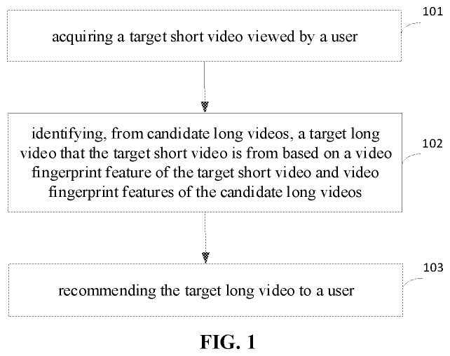

FIG. 1 is a flowchart illustrating a video recommendation method according to embodiments of the present disclosure.

A short video clipped from a long video is an effective propagation mode, which enables the long video, such as films, and TV series, to be propagated in the form of short video. Due to the propagation, users desire to know the long video that the short video is from.

With respect to this problem, embodiments of the present disclosure provide a video recommendation method to identify a target long video that a target short video viewed by the user is clipped from and recommended the target long video to the user.

As illustrated in FIG. 1, the video recommendation method may include the following.

At block 101, a target short video viewed by a user is acquired.

In detail, in response to detecting a request of resources of a target short video from a browser or a video playing application used by the user, content of the target short video to be viewed by the user may be acquired. The content may include an identifier, images and audios of the target short video.

At block 102, a target long video that the target short video is from is identified from candidate long videos based on a video fingerprint feature of the target short video and video fingerprint features of the candidate long videos.

In detail, a server for implementing the method according to embodiments may be configured to obtain the video fingerprint features of the candidate long videos in advance. Therefore, at least one of the candidate long videos having the video fingerprint feature matched with the video fingerprint feature of the target short video may be searched for, as the target long video. Since the video fingerprint feature is used to describe the content of the video, in response to that the target short video is from the target long video, the content of the target short video and the content of the target long video may be similar to each other, such that the video fingerprint features thereof may be matched with each other. In an example, the target long video that the target short video is from may be identified based on the video fingerprint feature, thereby increasing accuracy of identifying the target long video.

The video fingerprint feature may include an image feature and an audio feature, which may be obtained through feature extraction after a key frame is extracted from the video. The method for acquiring the video fingerprint feature will be described in detail below, which is not be described here.

At block 103, the target long video is recommended to the user.

In detail, a prompt message of the target long video may be displayed on a playing page for playing the target short video.

The prompt message herein may include at least one of an identifier of the target long video, a link of resources of the target long video, and an identifier of a video set including the target long video. For example, the identifier of the target long video may be the name of the target long video. The target long video may be one episode of a TV series, such that the identifier of the video set including the target long video may be the name of the TV series.

For example, the target short video is from an episode of the TV series. In response to identifying that the target short video is from the second episode of the TV series named A, the prompt message may be “From TV Series Named A, Click to View This TV Series”. Further, the prompt message may include the episode, such as “From Episode Two of TV Series Named A, Click to View This TV Series”.

Since the prompt message includes the link of resources of the target long video, in response to detecting that a target operation is performed by the user on the prompt message of the target long video, a playing page for playing the target long video may be displayed to play the target long video. The target operation may be an operation for triggering a jump to the playing page for playing the target long video, such as a click.

As a possible implementation, if the target short video is played in a full screen mode on the playing page, a floating control may be displayed on the playing page. The floating control may be configured to display the prompt message of the target long video and to respond to the target operation performed by the user.

As another possible implementation, if the target short video is played within a portion of a display region of the screen on the playing page, that is, a partial screen mode, the prompt message may be displayed on another portion of the display region on the playing page.

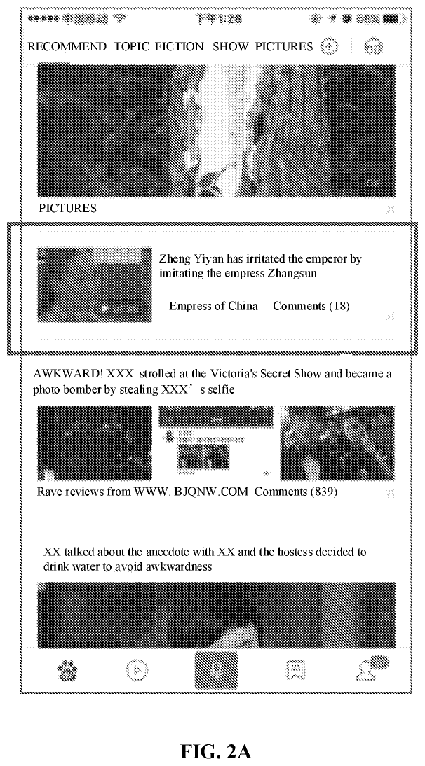

In order to clearly explain the implementation process of embodiments, the video recommendation method will be described in detail from a perspective of user operation in combination with the pages illustrated as FIG. 2A to FIG. 2D that are related to video playing.

1) A second short video is selected by the user from a list on a playlist page illustrated as FIG. 2A as the target short video. For example, the second short video may be selected by clicking a thumbnail of the second short video or clicking the name of the second short video, for example located on the right side of the thumbnail, such that the playlist page illustrated as FIG. 2A jumps to the playing page for playing the target short video illustrated as FIG. 2B, to play the target short video.

2) On the playing page illustrated as FIG. 2B, a playing region for playing the target short video is included and a display region for displaying the prompt message is included. For example, the display region may be located below the playing region. The prompt message displayed in the display area carries the link of resources of the target long video. In response to detecting the click operation by the user on the prompt message, the playing page illustrated as FIG. 2B jumps to the playing page for playing the target long video illustrated as FIG. 2D, and plays the target long video.

3) The target short video is played in the partial screen mode on the playing page illustrated as FIG. 2B. In response to detecting a full-screen operation is performed by the user on the playing page illustrated as FIG. 2B, the playing page illustrated as FIG. 2C may be obtained that the target short video is played in the full screen mode. In addition, the floating control may be displayed to display the prompt message of the target long video on the playing page illustrated as FIG. 2C. In response to detecting a click operation performed by the user on the floating control, the playing page illustrated as FIG. 2C jumps to the playing page for playing the target long video illustrated as FIG. 2D to play the target long video.

In embodiments, after the target short video viewed by a user is acquired, the target long video that the target short video is from may be identified amongst candidate long videos based on video fingerprint feature of the target short video and video fingerprint features of the candidate long videos, to recommend the target long video to the user. By identifying the target long video that the target short video is from amongst candidate long videos based on the video fingerprint feature, the target long video that the target short video is from may be identified even though no information related to the target long video is carried by the name of the target short video. In addition, the target long video is actively recommended to the user, such that a manual searching process by the user may be avoided, to solve a technical problem existing in the prior art that an operation for identifying a long video that a short video is from is inconvenient.

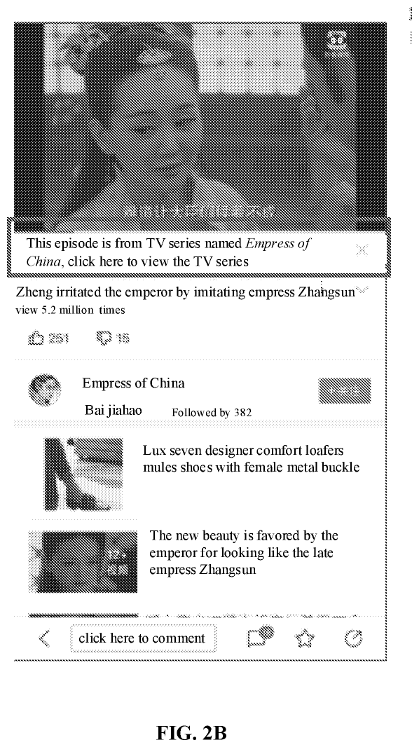

The above discussions focus on of the front end for recommending the target long video to the user. To further describe embodiments of the present disclosure, embodiments further provide a video recommendation method focusing on the background end for identifying the target long video that the target short video is from amongst the candidate long videos. FIG. 3 is a flowchart illustrating a video recommendation method according to embodiments of the present disclosure.

As illustrated in FIG. 3, the video recommendation method may include the following.

At block 201, a feature index library is established.

In detail, for each first key frame of each candidate long video, image feature extraction may be performed on multiple regions of each first key frame to obtain an image feature of the first key frame. The feature index library may be established based on the image features of respective first key frames of the candidate long videos.

The feature index library may have the image feature of each first key frame of each candidate long video stored therein. In an example, the target short video may be obtained by synthesizing frames selected from the target long video. In another example, frames may be selected from the target long video and each frame selected may be cut to obtain a partial frame such that the target short video may be obtained by synthesizing these partial frames. For example, a central region may be acquired from each frame selected and other regions such as captions at the bottom of each frame selected and signs at the four corners of each frame selected may be cut off from each frame selected to obtain the partial frame.

Therefore, in this case, in order to improve identification accuracy, each first key frame may be divided into a plurality of regions. Sizes of these regions may depend on a processing capability of the server for implementing the method according to embodiments of the present disclosure. The strong the processing capability is, the more the regions of each first key frame may be divided, and thus the number of pixels included in each region may be small.

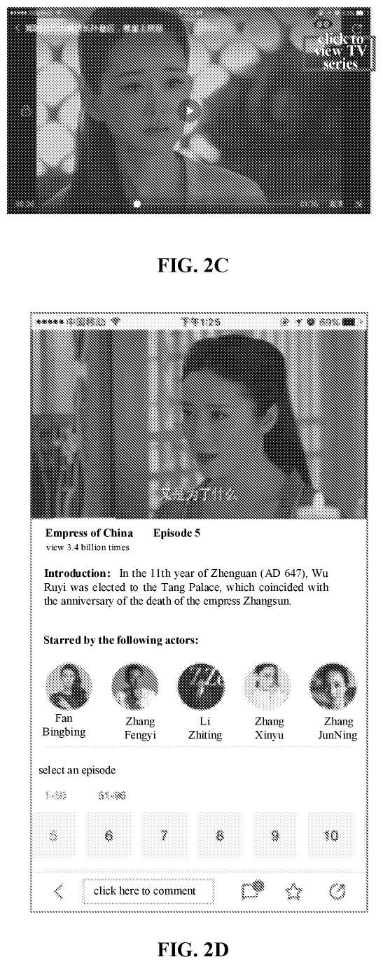

FIG. 4 is a schematic diagram illustrating multiple regions obtained by dividing a first key frame. As illustrated in FIG. 4, the regions may have no overlapping part to each other. In another possible implementation, adjacent regions may have an overlapping part, which is not limited in the present disclosure.

The feature extraction may be performed on each region of the first key frame. The image feature of each region may be determined as the image feature of the first key frame.

The feature index library may have the image feature of the first key frame and corresponding audio feature stored therein. As a possible implementation, for each first key frame, a piece of audio played within a period of time during which the first key frame is played is extracted. The feature extraction is performed on the piece of audio extracted to obtain an audio feature of the first key frame.

As discussed above, the feature index library may be established. In the feature index library established, respective image feature and corresponding audio feature of each first key frame are stored for each of the candidate long videos.

At block 202, a target short video viewed by a user is acquired, and a video fingerprint feature of the target short video is extracted.

Multiple second key frames of the target short video may be extracted based on image content of the target short video. For each second key frame of the target short video, an image feature of the second key frame may be extracted as the video fingerprint feature of the target short video.

As a possible implementation, after the image feature of the second key frame is extracted, for each second key frame, a piece of audio played within a period of time during which the second key frame is played may be extracted. The feature extraction is performed on the piece of audio extracted to obtain an audio feature of the second key frame. The image feature and the audio feature of each second key frame may be determined as the video fingerprint feature of the target short video.

At block 203, for each second key frame, one or more first key frames having the image feature matching with the image feature of the second key frame of the target short video are searched for from the feature index library, to obtain one or more target first key frame matching with the second key frame.

As discussed above, the image feature extraction may be performed on each region of the first key frame to obtain the image feature of the first key frame. Therefore, in a process of detecting whether the second key frame matches with the first key frame, it may be detected whether the number of the regions of the first key frame whose image feature matches with the image feature of the second key frame reaches a threshold. In response detecting that the number reaches the threshold, it may be determined that the second key frame matches with the first key frame. With the above detection, each first key frame may be compared with each second key frame in the feature index library to determine the one or more target first key frames that match with the second key frame. For example, multiple target first key frames may be determined, which may be from different candidate long videos respectively.

At block 204, a target long video is determined from the candidate long videos based on playing time point of each target first key frame from a same candidate long video and playing time point of each second key frame of the target short video.

The playing time point of each target first key frame of the target long video matches with the playing time point of each second key frame of the target short video.

As a possible implementation, the target short video may include multiple second key frames ranked in an order of playing time point, and each candidate long video may include multiple target first key frames ranked in an order of playing time point. Based on the playing time points of two second key frames, a playing interval may be calculated. If the candidate long video is the target long video, the above playing interval may be consistent to the playing interval between two target first key frames, from the candidate long video, corresponding to the above two second key frames. It should be noted that the consistency used herein refers to the consistency with a certain error.

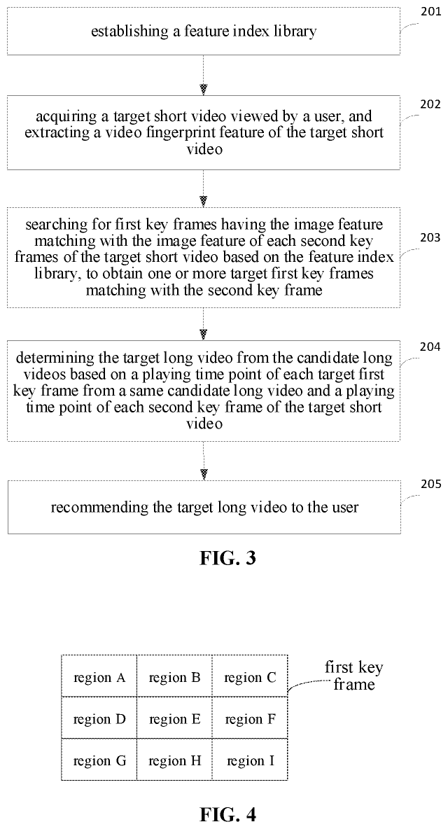

As another possible implementation, for each candidate long video, the playing time points of the multiple second key frames of the target short video may be represented on a vertical axis Y, while the playing time points of the multiple target first key frames of the candidate long video may be represented on a horizontal axis X to establish a coordinate system XY. The playing time point of the target first key frame may be represented by the value x, and the playing time point of the second key frame matching with the target first key frame may be represented by the value y. Therefore, the coordinate point (x, y) may be drawn in the coordinate system XY. As illustrated in FIG. 5, the coordinate points are fitted into a line. Based on a determination whether each coordinate point may be fitted into a line having a scope of about 1 (i.e., a linear relation), it may be determined whether the candidate long video is the target long video. If the candidate long video is the target long video, the coordinate points may be fitted by a linear relation.

At block 206, the target long video is recommended to the user.

Implementations of recommendation may refer to related descriptions above, and details are not described herein.

In embodiments, after the target short video viewed by the user is acquired, the target long video that the target short video is from may be identified from the candidate long videos based on the video fingerprint feature of the target short video and the video fingerprint features of the candidate long videos, such that the target long video may be recommended to the user. By identifying the target long video that the target short video is from amongst the candidate long videos based on the video fingerprint feature, the target long video that the target short video is from may be identified even though no information related to the target long video is carried in the name of the target short video. Furthermore, the target long video may be actively recommended to a user, such that a manual searching process by the user may be avoided to solve the technical problem existing in the prior art that an operation of identifying the long video that the short video is from is inconvenient. In addition, since the feature extraction is performed based on regions of the first key frame, the target long video may be accurately identified to avoid that it is unable to identify the target long video since each frame of the short video is a part of the frame of the long video.

In order to implement the above embodiments, the present disclosure also provides a video recommendation apparatus.

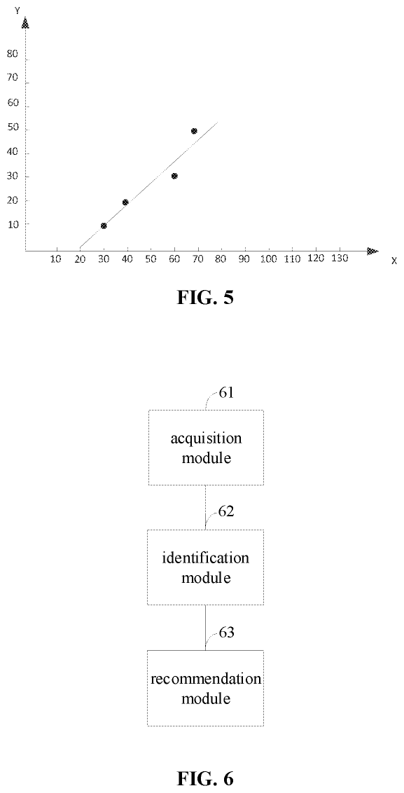

FIG. 6 is a block diagram illustrating a video recommendation apparatus according to embodiments of the present disclosure.

As illustrated in FIG. 6, the video recommendation apparatus may include: an acquisition module 61, an identification module 62, and a recommendation module 63.

The acquisition module 61 may be configured to acquire a target short video viewed by a user.

The identification module 62 may be configured to identify, from one or more candidate long videos, a target long video that the target short video is from based on a video fingerprint feature of the target short video and video fingerprint features of the candidate long videos.

The recommendation module 63 may be configured to recommend the target long video to the user.

For example, the recommendation module 63 may be configured to display a prompt message of the target long video on a playing page for playing the target short video. The prompt message includes at least one of an identifier of the target long video, a link of resources of the target long video, and an identifier of a video set including the target long video.

As a possible implementation, in response to detecting that the target short video is played in a full screen mode on the playing page, a floating control is displayed on the playing page. The floating control is configured to display the prompt message of the target long video and to respond to a target operation performed by the user.

As another possible implementation, in response to that the target short video is played within a portion of a display region on the playing page, the prompt message is displayed within another portion of the display area on the playing page.

Furthermore, in a possible implementation according to embodiments of the present disclosure, the recommendation module 63 may be configured to, in response to detecting the target operation performed by the user on the prompt message of the target long video, display a playing page for playing the target long video to play the target long video.

It is to be noted that the foregoing explanations of embodiments of the method may be also applicable to embodiments of the apparatus, which are not described herein.

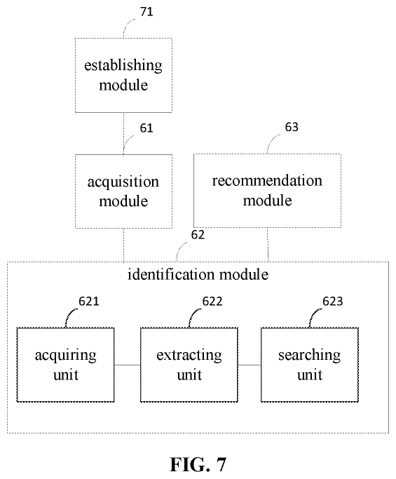

Based on the above descriptions, embodiments of the present disclosure further provide a possible implementation of a video recommendation apparatus. FIG. 7 is a block diagram illustrating a video recommendation apparatus according to embodiments of the present disclosure. As illustrated in FIG. 7, based on the above descriptions, the video recommendation apparatus may further include: an establishing module 71.

The establishing module 71 may be configured to extract a first key frame based on image content of each candidate long video to obtain multiple first key frames of each candidate long video; for each of the first key frames of each candidate long video, perform image feature extraction on multiple regions of each first key frame to obtain an image feature of each first key frame; and establish a feature index library based on the image feature of each first key frame of the candidate long videos.

The identification module 62 may include an acquiring unit 621, an extracting unit 622, and a searching unit 623.

The acquiring unit 621 may be configured to acquire the feature index library including the video fingerprint features of the candidate long videos. The video fingerprint feature includes an image feature and/or an audio feature.

The extracting unit 622 may be configured to extract the video fingerprint feature of the target short video.

For example, the extracting unit 622 may be configured to extract multiple second key frames of the target short video based on image content of the target short video; and extract an image feature of the second key frame as the video fingerprint feature of the target short video for each second key frame of the target short video.

The searching unit 623 may be configured to search for a candidate long video having the video fingerprint feature matching with the video fingerprint feature of the target short video based on the feature index library and determine the candidate long video as the target long video.

For example, the searching unit 623 may be configured to search for, from the feature index library, the first key frame having the image feature matching with the image feature of each second key frame to obtain the target first key frames matching with each second key frame; and determine the target long video from the candidate long videos based on playing time point of each target first key frame of the same candidate long video and playing time point of each second key frame of the target short video. The playing time point of each target first key frame of the target long video matches with the playing time point of each second key frame of the target short video.

In embodiments, after the target short video viewed by the user is acquired, the target long video that the target short video is from may be identified from the candidate long videos based on the video fingerprint feature of the target short video and the video fingerprint features of the candidate long videos, such that the target long video may be recommended to the user. By identifying the target long video that the target short video is from amongst the candidate long videos based on the video fingerprint feature, the target long video that the target short video is from may be identified even though no information related to the target long video is carried in the name of the target short video. Furthermore, the target long video may be actively recommended to a user, such that a manual searching process by the user may be avoided to solve the technical problem existing in the prior art that an operation of identifying the long video that the short video is from is inconvenient. In addition, since the feature extraction is performed based on regions of the first key frame, the target long video may be accurately identified to avoid that it is unable to identify the target long video since each frame of the short video is a part of the frame of the long video.

In order to achieve the above objectives, embodiments of the present disclosure provide a computer device. The computer device may include a memory, a processor, and a computer program stored on the memory and executable by the processor. When the computer program is executed by the processor, the video recommendation method may be implemented.

In order to achieve the above objectives, embodiments of the present disclosure provide a non-transitory computer readable storage medium having a computer program stored thereon. When the program is executed by the processor, the video recommendation method may be implemented.

In order to achieve the above objectives, embodiments of the present disclosure provide a computer program product. When an instruction in the computer program product is executed by a processor, the video recommendation method may be implemented.

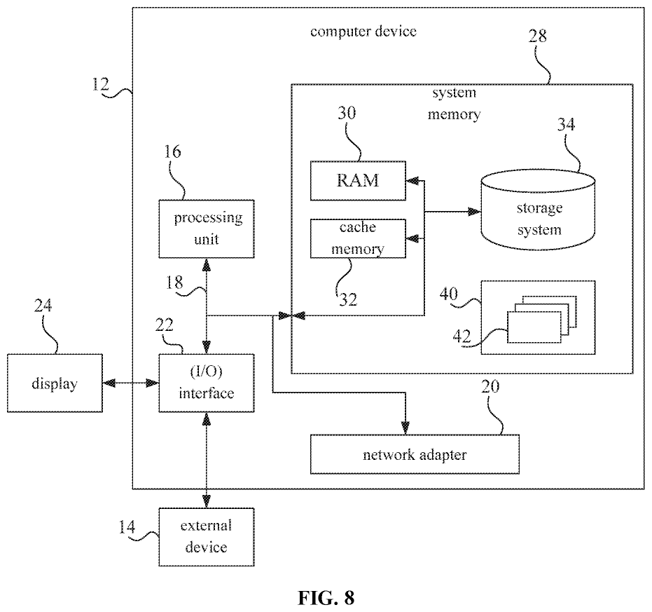

FIG. 8 is a block diagram illustrating an exemplary computer device suitable for implementing embodiments of the present disclosure. The computer device 12 shown in FIG. 8 is merely an example and should not impose any limitation on the function and scope of use of the embodiments of the present disclosure.

As illustrated in FIG. 8, the computer device 12 may be represented via a general computer device form. Components of the computer device 12 may include but be not limited to one or more processors or processing units 16, a system memory 28, a bus 18 connecting various system components including the system memory 28 and the processing units 16.

The bus 18 represents one or more of several types of bus structures, including a memory bus or a memory controller, a peripheral bus, a graphics acceleration port, a processor, or a local bus using any of a variety of bus structures. For example, these architectures include, but are not limited to, an Industry Standard Architecture (hereinafter referred to as ISA) bus, a Micro Channel Architecture (hereinafter referred to as MAC) bus, an enhanced ISA bus, a Video Electronics Standards Association (hereinafter referred to as VESA) local bus and Peripheral Component Interconnection (PCI) bus.

The computer device 12 typically includes a variety of computer system readable media. These media may be any available media accessible by the computer device 12 and includes both volatile and non-volatile media, removable and non-removable media.

The system memory 28 may include a computer system readable medium in the form of volatile memory, such as a random access memory (hereinafter referred to as RAM) 30 and/or a high speed cache memory 32. The computer device 12 may further include other removable or non-removable, volatile or non-volatile computer system storage media. By way of example only, the storage system 34 may be configured to read and write a non-removable and non-volatile magnetic media (not shown in FIG. 8, commonly referred to as a “hard drive”). Although not shown in FIG. 8, a magnetic disk driver for reading from and writing to a removable and non-volatile magnetic disk (such as “floppy disk”) and a disk driver for a removable and non-volatile optical disk (such as compact disk read only memory (hereinafter referred to as CD-ROM), Digital Video Disc Read Only Memory (hereinafter referred to as DVD-ROM) or other optical media) may be provided. In these cases, each driver may be connected to the bus 18 via one or more data medium interfaces. The memory 28 may include at least one program product. The program product has a set (such as, at least one) of program modules configured to perform the functions of various embodiments of the present disclosure.

A program/utility 40 having a set (at least one) of the program modules 42 may be stored in, for example, the memory 28. The program modules 42 include but are not limited to, an operating system, one or more application programs, other programs modules, and program data. Each of these examples, or some combination thereof, may include an implementation of a network environment. The program modules 42 generally perform the functions and/or methods in the embodiments described herein.

The computer device 12 may also communicate with one or more external devices 14 (such as, a keyboard, a pointing device, a display 24, etc.). Furthermore, the computer device 12 may also communicate with one or more communication devices enabling a user to interact with the computer device 12 and/or other devices (such as a network card, modem, etc.) enabling the computer device 12 to communicate with one or more computer devices. This communication can be performed via the input/output (I/O) interface 22. Also, the computer device 12 may communicate with one or more networks (such as a local area network (hereafter referred to as LAN), a wide area network (hereafter referred to as WAN) and/or a public network such as an Internet) through a network adapter 20. As shown in FIG. 6, the network adapter 20 communicates with other modules of the computer device 12 over the bus 18. It should be understood that, although not shown in FIG. 6, other hardware and/or software modules may be used in connection with the computer device 12. The hardware and/or software includes, but is not limited to, microcode, device drivers, redundant processing units, external disk drive arrays, RAID systems, tap Drive and data backup storage system.

The processing unit 16 is configured to execute various functional applications and data processing by running programs stored in the system memory 28, for example, implementing the speech noise reduction method based on AI provided in embodiments of the present disclosure.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

1. A video recommendation method, comprising:
acquiring a target short video;
identifying, from candidate long videos, a target long video that the target short video is from based on a video fingerprint feature of the target short video and video fingerprint features of the candidate long videos; and
recommending the target long video.

2. The video recommendation method according to claim 1, wherein recommending the target long video comprises:
displaying a prompt message of the target long video on a playing page for playing the target short video, wherein the prompt information comprises at least one of an identifier of the target long video, a link of resources of the target long video, and an identifier of a long video set comprising the target long video.

3. The video recommendation method according to claim 2, further comprising:
in response to detecting a target operation performed on the prompt message of the target long video, displaying a playing page for playing the target long video to play the target long video.

4. The video recommendation method according to claim 2, wherein displaying the prompt message of the target long video on the playing page for playing the target short video comprises:
in response to detecting that the target short video is played in a full screen mode on the playing page, displaying a floating control on the playing page, wherein the floating control is configured to display the prompt message of the target long video and to respond to the target operation performed on the prompt message; and
in response to that the target short video is played within a portion of a display region on the playing page, displaying the prompt message within another portion of the display region on the playing page.

5. The video recommendation method according to claim 1, wherein identifying, from the candidate long videos, the target long video that the target short video is from based on the video fingerprint feature of the target short video and the video fingerprint features of the candidate long videos comprises:
acquiring a feature index library, the feature index library comprising the video fingerprint features of the candidate long videos, wherein the video fingerprint feature comprises an image feature and/or an audio feature;
extracting the video fingerprint feature of the target short video; and
searching for a candidate long video having the video fingerprint feature matching with the video fingerprint feature of the target short video based on the feature index library, as the target long video.

6. The video recommendation method according to claim 5, further comprising:
extracting first key frames based on image content of each candidate long video to obtain a plurality of first key frames for each candidate long video;
for each first key frame of the candidate long videos, performing image feature extraction on a plurality of regions of the first key frame to obtain an image feature of the first key frame; and
establishing the feature index library based on the image feature of each first key frame of the candidate long videos.

7. The video recommendation method according to claim 6, wherein extracting the video fingerprint feature of the target short video comprises:
extracting a plurality of second key frames of the target short video based on image content of the target short video; and
for each second key frame of the target short video, extracting an image feature of the second key frame as the video fingerprint feature of the target short video.

8. The video recommendation method according to claim 7, wherein searching for the candidate long video having the video fingerprint feature matching with the video fingerprint feature of the target short video based on the feature index library, as the target long video comprising:
searching for a first key frame having the image feature matching with the image feature of each second key frame of the target short video from the feature index library, to obtain one or more target first key frames matching with the second key frame; and
determining the target long video from the candidate long videos based on a playing time point of each target first key frame from a same candidate long video and a playing time point of each second key frame of the target short video, wherein the playing time point of each target first key frame of the target long video matches with the playing time point of a respective second key frame of the target short video.

9.-16. (canceled)

17. A computer device comprising: a memory, a processor, and a computer program stored on the memory and executable by the processor, wherein when the computer program is executed by the processor, the processor is configured to
acquire a target short video;
identify, from candidate long videos, a target long video that the target short video is from based on a video fingerprint feature of the target short video and video fingerprint features of the candidate long videos; and
recommend the target long video.

18. A non-transitory computer readable storage medium having a computer program stored thereon, wherein when the program is executed by a processor, a video recommendation method is implemented, wherein the video recommendation method comprises:
acquiring a target short video;
identifying, from candidate long videos, a target long video that the target short video is from based on a video fingerprint feature of the target short video and video fingerprint features of the candidate long videos; and
recommending the target long video.

19. (canceled)

20. The computer device according to claim 17, wherein the processor is further configured to:
display a prompt message of the target long video on a playing page for playing the target short video, wherein the prompt information comprises at least one of an identifier of the target long video, a link of resources of the target long video, and an identifier of a long video set comprising the target long video.

21. The computer device according to claim 20, wherein the processor is further configured to:
in response to detecting a target operation performed by the user on the prompt message of the target long video, display a playing page for playing the target long video to play the target long video.

22. The computer device according to claim 20, wherein the processor is further configured to:
in response to detecting that the target short video is played in a full screen mode on the playing page, display a floating control on the playing page, wherein the floating control is configured to display the prompt message of the target long video and to respond to the target operation performed by the user performed on the prompt message; and
in response to that the target short video is played within a portion of a display region on the playing page, display the prompt message within another portion of the display region on the playing page.

23. The computer device according to claim 17, wherein the processor is further configured to:
acquire a feature index library, the feature index library comprising the video fingerprint features of the candidate long videos, wherein the video fingerprint feature comprises an image feature and/or an audio feature;
extract the video fingerprint feature of the target short video; and
search for a candidate long video having the video fingerprint feature matching with the video fingerprint feature of the target short video based on the feature index library, as the target long video.

24. The computer device according to claim 23, wherein the processor is further configured to:
extract first key frames based on image content of each candidate long video to obtain a plurality of first key frames for each candidate long video;
for each first key frame of the candidate long videos, perform image feature extraction on a plurality of regions of the first key frame to obtain an image feature of the first key frame; and
establish the feature index library based on the image feature of each first key frame of the candidate long videos.

25. The computer device according to claim 24, wherein the processor is further configured to:
extract a plurality of second key frames of the target short video based on image content of the target short video; and
for each second key frame of the target short video, extract an image feature of the second key frame as the video fingerprint feature of the target short video.

26. The computer device according to claim 25, wherein the processor is further configured to:
search for a first key frame having the image feature matching with the image feature of each second key frame of the target short video from the feature index library, to obtain one or more target first key frames matching with the second key frame; and
determine the target long video from the candidate long videos based on a playing time point of each target first key frame from a same candidate long video and a playing time point of each second key frame of the target short video, wherein the playing time point of each target first key frame of the target long video matches with the playing time point of a respective second key frame of the target short video.

27. The non-transitory computer readable storage medium according to claim 18, wherein recommending the target long video comprises:
displaying a prompt message of the target long video on a playing page for playing the target short video, wherein the prompt information comprises at least one of an identifier of the target long video, a link of resources of the target long video, and an identifier of a long video set comprising the target long video.

28. The non-transitory computer readable storage medium according to claim 27, wherein the video recommendation method further comprises:
in response to detecting a target operation performed on the prompt message of the target long video, displaying a playing page for playing the target long video to play the target long video.

29. The non-transitory computer readable storage medium according to claim 27, wherein displaying the prompt message of the target long video on the playing page for playing the target short video comprises:
in response to detecting that the target short video is played in a full screen mode on the playing page, displaying a floating control on the playing page, wherein the floating control is configured to display the prompt message of the target long video and to respond to the target operation performed on the prompt message; and
in response to that the target short video is played within a portion of a display region on the playing page, displaying the prompt message within another portion of the display region on the playing page.
